(19) United States
(12) Patent Application Publication
(10) Pub. No.: US 2013/0019723 A1
(43) Pub. Date: Jan. 24, 2013

(54) PRINTING SYSTEM AND METHOD WITH VARIABLE ROTARY CUTTING CAPABILITY

(71) Applicants: Thomas Lee Nadrchal, Mokena, IL (US); John Matthias Nader, Valparaiso, IN (US); Thomas James Payer, Valparaiso, IN (US); Robert Steven Orto, Valparaiso, IN (US)

(72) Inventors: Thomas Lee Nadrchal, Mokena, IL (US); John Matthias Nader, Valparaiso, IN (US); Thomas James Payer, Valparaiso, IN (US); Robert Steven Orto, Valparaiso, IN (US)

(73) Assignee: GLOBAL WEB FINISHING, Merrillville, IN (US)

(21) Appl. No.: 13/556,118

(22) Filed: Jul. 23, 2012

Related U.S. Application Data
(60) Provisional application No. 61/510,537, filed on Jul. 22, 2011.

(51) Int. Cl. B26D 5/00; B26D 1/36

(52) U.S. Cl. 83/13; 83/76.6

(57) ABSTRACT

Systems and methods for performing a variable rotary cutting operation on a web. A desired product length is inputted into a software program that identifies therewith a first of multiple cassettes that are interchangeably installable in a cutting apparatus. Each cassette includes a knife cylinder having multiple knife holders mounted thereto in which multiple knives are installed. The software program further identifies a number of knife holders and a rotational speed for the knife cylinder that differs from the speed of the web and achieves the desired product length. The first cassette is installed in the cutting apparatus and the web is fed through a variable repeat printer and thereafter through the first cassette. The variable repeat printer prints images on the web and the knife cylinder is rotated at the rotational speed identified by the software program to produce the desired product length.

### CROSS REFERENCE TO RELATED APPLICATIONS

This application claims the benefit of U.S. Provisional Application No. 61/510,537, filed Jul. 22, 2011, the contents of which are incorporated herein by reference.

### BACKGROUND OF THE INVENTION

The present invention generally relates to equipment and processes used in the commercial printing industry. More particularly, this invention relates to equipment and processes for cutting to length various image sizes produced by a variable repeat print engine.

Conventional commercial web offset printing is performed with rotary fixed-circumference (repeat) printing cylinders in combination with a rotary cutter. Conventionally, the circumference of a printing cylinder is wrapped with printing plates that contain multiple common-length images that are equally spaced around the circumference of the printing cylinder, and by which equally-spaced printed images are created on a web fed through the printing cylinder. The rotary cutter comprises a cutting or knife cylinder equipped with knives that cut the printed web against a hardened anvil cylinder as the printed web passes between the counter-rotating cylinders, producing finished products having the common-length printed images. The cutting couple of a rotary cutter designed to cut the individual printed images to length has the same circumference as the printing cylinder so that the surface speed of the knives matches the web speed of the printed web.

During a web-fed printing process, depending on desired final print product length, relative same length image repeats are stepped and repeated in the web direction up or around the plate cylinder, where unlike multi-color print images at the corresponding head and foot of adjacent products meet. When print images are transferred to the web and subsequently cut off at final product size, it is not practical to use a single knife to separate an adjacent pair of print images at the precise meeting point of their corresponding head and foot. Therefore, the cutting of multi-color print images typically requires a double knife cut, known in the industry as a cross cut rotary “bleed trim,” which produces a waste “chip” that is discarded from the finished products via a waste extraction system, of which various types are known.

Traditionally rotary bleed trimming in the cross web direction requires a knife cylinder having at least one but more often multiple sets of two consecutive knives, each set acting as a pair and positioned on the knife cylinder to exactly meet the running web at an appropriate surface speed and timing to create a double cross-cut bleed trim at the head and foot of each consecutive product and thereby separate individual products from the running web. The term “step” is used in the industry to refer to the precise physical distance a print image is repeated on a printed web. The step includes the sum of the actual image print length and the total length of the bleed trim, defining a physical distance for the image length to step prior to “repeating” itself within a finite rotary image cylinder circumference or within a fully infinite length without any predetermined step and repeat limitations (symmetrical bleed).

With traditional fixed-circumference offset printing plates and print lengths sized for the circumference of a printing cylinder or the overall size repeat of the printing press, the predeterminable step and repeat of a printed image is finite within the range of numbers of printed images (commonly one through five) that can be produced by a printing cylinder and accommodated by the rotary cutter set up to specifically match the image step and repeat of the printing cylinder. Finished image (product) lengths are adjustable within a limited range by the number of images on the circumference of the printing cylinder along with adjusting the chip size between printed images. Dividing the circumference in even angular slices to match the number of printed images per circumference along with chip size determines the angular placements of the knives on the knife cylinder. Changing the location of each knife holder on a knife cylinder to match the number of images and chip size between images from job to job requires considerable “make ready” time, resulting in costly idle downtime of the finishing system.

Commercial printing is rapidly moving into the use of variable repeat print engines, particularly notable examples of which are cylindrical or digital inkjet printing technologies. Unlike conventional web offset printing using fixed-circumference printing cylinders, inkjet technologies offer virtually any image (product) length to be printed on demand based on the electronic print format input. In this case, a print image repeated on a printed web is referred to as a “document,” and a step includes the sum of the document print length and the length of the bleed trim within the length of web prior to the document being repeated. Certain inkjet technologies include a periodic purge of the ink jets, creating what has been referred to as a service bar that spans the width of the web and creates a non-symmetrical bleed. Such a purge typically occurs after the printing of several documents along a length of web, and the length of a service bar, for example, about 12 mm, must be accommodated by the printing process. The result may be termed a predetermined and semipermanently fixed “frame” length that includes the sum of the document print lengths, the bleed trim lengths, and the service bar length that are all within a length of the web prior to the frame being repeated.

While variable repeat print technologies enable the document print length, step and frame length to be varied from job to job, they are limited by the make-ready requirements of conventional knife cylinders used to cut the individual digitally-printed products to length. Consequently, methods and equipment are needed that are capable of cutting variable equal length images and removing bleed waste between images, while also being more capable of accommodating the ability of variable repeat print technologies to vary document print length, step and frame length from job to job.

### BRIEF DESCRIPTION OF INVENTION

The present invention provides systems and methods suitable for performing a variable rotary cutting operation on a web, and particularly a web having images produced using variable repeat printing technologies.

According to a first aspect of the invention, a printing system is provided that includes a variable repeat printing means for printing images on the web as the web passes therethrough at a web speed, and a cutting apparatus adapted to receive the web from the variable repeat printing means. Multiple cassettes comprising at least first and second cassettes are interchangeably installable in the cutting apparatus. The first cassette comprises a first knife cylinder comprising multiple knife holders and multiple knives installed therein, and the second cassette comprises a second knife cylinder comprising multiple knife holders and multiple knives installed therein. Each of the first and second knife cylinders is adapted to perform a rotary cutting operation on the web after the images are printed thereon by the variable repeat printing means. The cutting apparatus further includes means for controlling a rotational speed of the first and second knife cylinders when the first or second cassette, respectively, is installed in the cutting apparatus, and a software program that utilizes a desired product length as an input and utilizes the input to identify one of the multiple cassettes, a number of the knife holders thereof, and a rotational speed for the knife cylinder thereof that is an over-speed or under-speed condition relative to the web speed and achieves the desired product length. The software program also generates an output to the variable repeat printing means that causes the variable repeat printing means to alter spacing between the images printed by the variable repeat printing means on the web.

A second aspect of the invention is a process of using a printing system comprising the elements described above to perform a variable rotary cutting operation on a web.

Another aspect of the invention is a method of performing a variable rotary cutting operation on a web, in which a desired product length is inputted into a software program that identifies therewith a first of multiple cassettes that are interchangeably installable in a cutting apparatus. Each of the multiple cassettes comprises a knife cylinder having multiple knife holders mounted thereto in which multiple knives are installed. The software program further identifies a number of the knife holders and a rotational speed for the knife cylinder that is an over-speed or under-speed condition relative to a web speed of the web and achieves the desired product length, and generates an output to a variable repeat printing means that the variable repeat printing means uses to determine spacing between images printed by the variable repeat printing means on the web. Thereafter, the first cassette having the number of the knife holders identified by the software program is installed in the cutting apparatus, and the web is fed through the variable repeat printing means and thereafter through the first cassette. The variable repeat printing means prints images on the web having the spacing therebetween, and the knife cylinder of the first cassette is rotated at the rotational speed identified by the software program to cause the knife cylinder to produce the desired product length.

A technical effect of the invention is the use of a software program to prompt the operator of a printing system to input a desired final product length for a printing operation that utilizes a variable repeat printing technology, and then allowing the software program to identify operating parameters of a rotary knife cylinder that will achieve the desired final product length. In so doing, the operation of the printing system can be tailored on a job-by-job basis while minimizing the need to reconfigure the rotary knife cylinder for each separate printing job.

Other aspects and advantages of this invention will be better appreciated from the following detailed description.

### BRIEF DESCRIPTION OF THE DRAWINGS

FIG. 1 schematically represents a knife cylinder and a portion of an adjacent anvil cylinder, which together make up a variable rotary cutter suitable for use with embodiments of this invention.

FIG. 2 schematically represents a printing system that includes a cutting apparatus configured to accept multiple cassettes, each comprising a pair of knife and anvil cylinders in accordance with a preferred aspect of the invention.

### DETAILED DESCRIPTION OF THE INVENTION

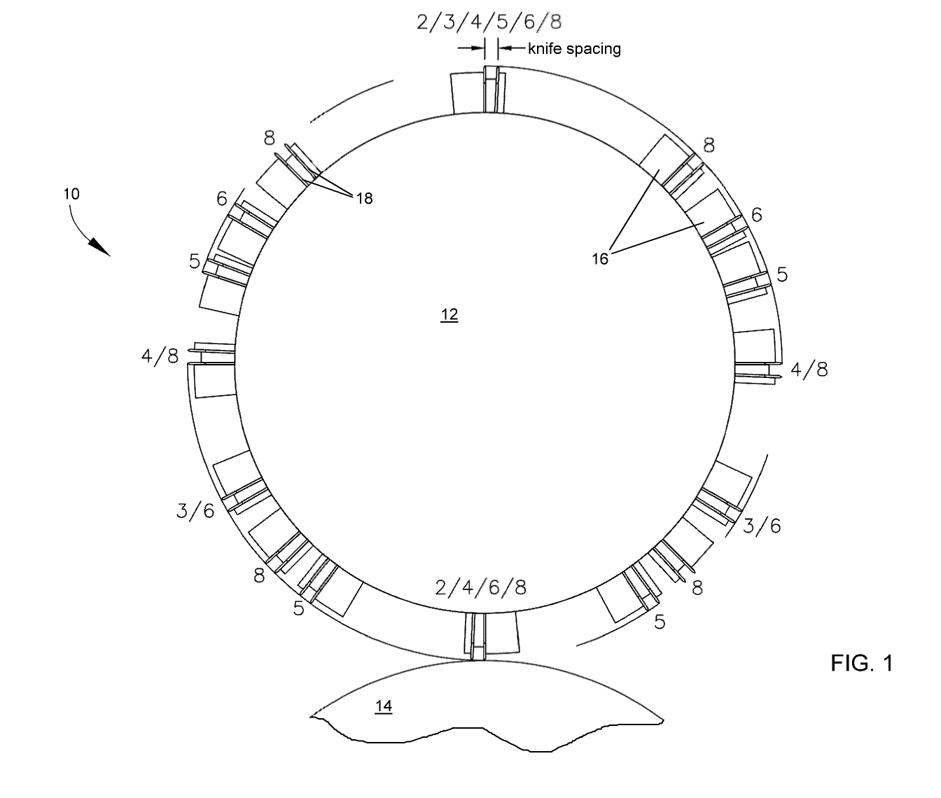

The present invention provides a variable on-demand (VOD) rotary cutting system and method that are adapted to match fixed-circumference rotary cylinder cutting couples to variable print image lengths produced on a web by a digital electronic inkjet press (or other variable repeat print technology). An example of a suitable knife cylinder 12 for this purpose is schematically represented in FIG. 1, along with a portion of an anvil cylinder 14 of a type conventionally used in combination with knife cylinders. It should be understood that the knife cylinder 12 is representative of a type that can be employed by the invention, and that the invention is not limited to the configuration of the knife cylinder 12 in FIG. 1.

The knife and anvil cylinders 12 and 14 are both represented as being fixed-circumference rotary cylinders. Together, the knife cylinder 12 and anvil cylinder 14 make up a variable rotary cutter 10 adapted to perform an operation on a web material (not shown), as understood by those skilled in the art. The knife cylinder 12 can have any suitable construction and a circumference and length appropriate for the particular application. As non limiting examples, suitable sizes for knife cylinders include circumferences of 28.25, 31.50 and 35 inches (about 71.8, 80.0 and 88.9 cm, respectively). The knife cylinder 12 is shown as being equipped with a series of knife holders 16 spaced circumferentially around its entire circumference. Various configurations are known or foreseeable for the holders 16, as are techniques for securing the holders 16 to the knife cylinder 12. The knife holders 16 are preferably (but not necessarily) removably secured to the knife cylinder 12, enabling the knife holders 16 to be relocated on the cylinder 12 and thereby enabling the cylinder 12 to be reconfigured for different print jobs. The knife holders 16 are adapted for mounting knives 18 to the cylinder 12 in any suitable manner. The knives 18 are preferably adapted to be mounted in and removed from the knife holders 16, further enabling the cylinder 12 to be reconfigured for different print jobs. Though pairs of consecutive knives 18 are represented in FIG. 1 as mounted in each of the knife holders 16, it should be understood that this configuration is for purposes of illustration and that knives 18 will typically be absent from one or more of the knife holders 16 as a result of the cylinder 12 being made ready for a particular printing job. As understood in the art, pairs of consecutive knives 18 mounted in a single holder 16 are adapted to produce a bleed cut, though it should be understood that each knife 18 of a pair of consecutive knives 18 used to produce a bleed cut could be mounted in separate holders 16. Those skilled in the art will also appreciate that the knives 18 can be configured to completely sever or only perforate a web, depending on the particular job being performed.

The circumferential spacing between a pair of consecutive knives 18 determines the bleed chip size. As evident from FIG. 1, the circumferential spacing between each pair of consecutive knives 18 is fixed, in that their spacing cannot be adjusted without somehow relocating one or both knives 18 in the holder(s) 16 in some manner. With the use of a digital inkjet print engine, bleed chip size can be readily kept to a minimum physical length, for example, about 0.25 inch (about 6 mm) to minimize waste, which can serve as an acceptable fixed knife spacing for a pair of consecutive knives 18 on the knife cylinder 12. The locations of knives 18 on the knife cylinder 12 also determine product length. The knife cylinder 12 depicted in FIG. 1 may be considered a “multi-make ready” cylinder 12, in that it comprises multiple knife holders 16 angularly spaced around the circumference of the cylinder 12 to enable knives 18 to be mounted in various combinations on the cylinder 12. In the embodiment represented in FIG. 1, the knife holders 16 are spaced to be able to mount knives 18 to achieve product cut lengths for two, three, four, five, six, and eight images per fixed circumference of the cutting couple, though the invention is not limited to any particular image per fixed circumference. For reference, positions of knives 18 for each of these image per fixed circumference scenarios are indicated in FIG. 1.

The presence of premounted knife holders 16 on the multi-make ready knife cylinder 12 greatly reduces the make-ready time required to configure the cylinder 12 between different print jobs. The task of locating and mounting the knife holders 16 between jobs is eliminated, and only the knives 18 need to be mounted or relocated. As an example, if job “A” require knives 18 to be mounted in premounted holders 16 for three images per cylinder circumference, and job “B” requires knives 18 to be mounted in premounted holders 16 for four images per cylinder circumference, make-ready between jobs A and B entails relocating two sets of knives 18 in two holders 16 and installing a fourth set of knives 18 in a fourth holder 16.

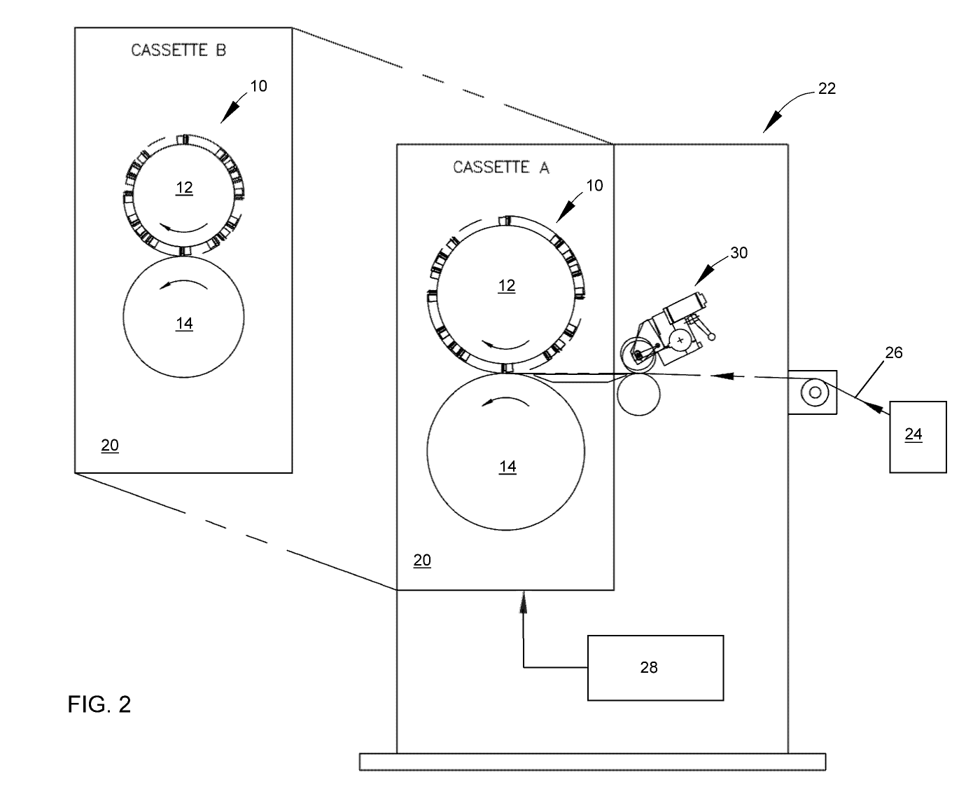

As should be understood, the product length can be varied by adjusting the bleed chip size, which in turn is determined by the circumferential spacing between at least one pair of consecutive knives 18 located on the knife cylinder 12 for this purpose. However, adjustment of the bleed chip size may not be desirable or possible, depending on the configurations of the knife holders 16. To vary the finished printed image length without adjusting the chip size, over-speed and/or under-speed control of the rotation of the fixed-size cutting couple defined by the knife cylinder 12 and the anvil cylinder 14 (whose rotational speeds are the same). According to a preferred aspect of the invention, the rotational speed of the cutting couple can be controlled within a range so that the surface speed of the knives 18 is faster or slower than the linear web speed. The percentage of surface speed mismatch between the knives 18 relative to the web speed will result in an altered finished image cut length by the respective percentage of speed mismatch. For example, an 8.00-inch (about 20 cm) finished product length with a 10% over-speed of the cutting couple relative to the web speed results in a reduced product length of about 7.20 inches (about 18.3 cm). Under-speeding the cutting couple has the opposite affect, resulting in a 10% longer product length (about 8.8 inches, or about 22.4 cm). The ability to adjust the constant speed of the cutting couple relative to web speed can be accomplished with, for example, an independent drive motor (schematically represented at 28 in FIG. 2) that allows for a desired range of finished product lengths. In investigations leading up to the present invention, speed mismatches (knife cylinder to web surface speed) over a range of −5% up to +15% have been successfully demonstrated with full bleed cut-off formats (about 0.25 inch) with knife cylinders 12 having circumferences of 28.25, 31.50 and 35 inches (about 71.8, 80.0 and 88.9 cm, respectively). Investigations also successfully demonstrated speed mismatches of −10% up to +30% with single knife cut (non-bleed) formats. It is foreseeable that larger ranges can be achieved as further web control elements are developed.

Although having the ability to adjust product length via varying the speed of the cutting couple provides a wider range of product lengths, in some instances the range of product lengths may not be sufficient to cover a full range of desired product lengths. Accordingly, another aspect of this method involves changing the cutting couple circumference through the use of cassettes 20, each containing a cutting couple (knife and anvil cylinders 12 and 14) and interchangeably installable in a cutting apparatus 22, as represented in FIG. 2. The cassettes 20 can be adapted for installation in the cutting apparatus 22 in any suitable manner, and to receive a printed web 26 from a printer 24 as also schematically represented in FIG. 2. The cutting apparatus 22 is represented as further including a nip roller 30 that maintains an appropriate tension in the web 26. The implementation of interchangeable cassettes 20 is enabled by the use of a digital inkjet printer (or other suitable variable repeat print technology) as the printer 24, in that the circumference of the cutting couple is no longer required to match the fixed repeat of a specific fixed-circumference printing cylinder. As a result, it is possible to identify an optimal circumference from among two or more cassettes 20 that, in combination with the ability to alter the rotational speed of a chosen cassette's cutting couple as described above, can fill in the gaps of product sizes to cover a broader range of product lengths, for example, those accepted by current postal mail system size limitations.

Finally, in order to choose a cassette 20 having an optimal “multi-make ready” cutting couple and an appropriate over-speed or under-speed operating condition controlled by the drive motor 28, the present invention makes use of a software program to identify the most optimal choice among the available cassettes 20 that will require the least degree of speed mismatch to produce a desired finished product length from a web 26 on which images have been printed by the printer 24. For this purpose, the software program preferably calculates “virtual” cutting couple circumference sizes by taking the desired finished product length entered by the operator of the apparatus 22, and determines the optimum number of products per circumference of the closest cassette choice by comparing the “virtual” circumference size to each cassette circumference size. As a result of this calculation, the program is able to provide as output to the operator the identity of a cassette 20 and number of knife holders 16. The operator can then simply install the identified cassette 20 in the apparatus 22 (if not already installed) and mount the appropriate number of knives 18 into the knife holders 16 identified by the program. In addition, the software program also calculates any percentage of speed mismatch (+/−) necessary to produce the desired product length cuts based on the size (circumference) of the cutting couple of the installed cassette 20. This percentage of speed mismatch is an output of the program that can be automatically or manually entered as input to the program that controls the printer 24 used to print the images on the web 26 so that the theoretical fixed knife spacing between the printed images on the web 26 can be adjusted to take into account the altered bleed chip size resulting from the speed mismatch.

As a nonlimiting example of the above, upon an operator entering a finished product length of 8.00 inches (about 20 cm) as input into the software program, the program calculates the optimum “virtual” repeat which, for example, may indicate the use of cassette “A” with four products per circumference and a 0.25 inch (about 6 mm) spacing between each pair of consecutive knives 18, and further calculates the need for a 5% over-speed condition to achieve the finished product length.

While achieving the desired finished product length, the over-speed condition also alters the bleed chip length removed from the web 26 by a pair of consecutive knives 18. For example, a pair of consecutive knives 18 having a fixed circumferential spacing of 0.25 inch will produce a bleed chip whose length is less than 0.25 inch as a result of an over-speed condition of the knife cylinder 12 relative to the web speed. For the purpose of eliminating or at least reducing the amount of make-ready that must be performed on a knife cylinder 12, the circumferential spacing between the knives 18 is preferably not adjusted to accommodate the bleed chip length, and instead this effect is preferably accommodated at the printing operation where distances between printed images (documents) are established that take into account the removal of bleed chips. To do this, the software program can provide as output to the printer 24 a calculated adjusted image spacing that accounts for any bleed trimming length distortion (shortening or lengthening) resulting from the knife cylinder 12 operating an over-speed or under-speed condition relative to the web 26. For example, based on a spacing of 0.25 inch between a pair of consecutive knives 18 and a 5% over-speed condition for the knife cylinder 12, the adjusted imaging spacing can be calculated as follows:

(0.25″ knife spacing)−(5% of 0.25 inch due to over-speed)=0.2375 inch

The calculated distance is then used as the length of the space that is between printed images and will be removed by a pair of consecutive knives 18. Under-speeding the cutting couple would have the opposite affect by lengthening the chip size by the percentage of speed mismatch. Finally, a similar calculation would be required if the printer 24 operates with a purge cycle resulting in the presence of a service bar in the printed web 26. Notably, the circumferential spacing between a pair of knives 18 intended to remove the service bar from a web 26 would likely differ from that of other pairs of knives 18 intended to make bleed cuts in the web 26, though the proportional adjustment would be the same using a similar calculation.

In view of the above, it should be apparent that the invention makes use of interchangeable cassettes 20 containing “multi-make ready” knife cylinders 12 and cutting couple speed control in combination with a software program that calculates and provides as outputs the necessary “pre-press” and digital layout to produce a full range of cut-to-length image sizes on demand.

While the invention has been described in terms of specific embodiments, it is apparent that other forms could be adopted by one skilled in the art. For example, the physical configurations of the knife cylinders 12 and cutting apparatus 22 could differ from that shown. Therefore, the scope of the invention is to be limited only by the following claims.

1. A printing system adapted to perform a variable rotary cutting operation on a web, the printing system comprising:
a variable repeat printing means for printing images on the web as the web passes therethrough at a web speed;
a cutting apparatus adapted to receive the web from the variable repeat printing means;
multiple cassettes comprising at least first and second cassettes interchangeably installable in the cutting apparatus, the first cassette comprising a first knife cylinder comprising multiple knife holders and multiple knives installed therein, the second cassette comprising a second knife cylinder comprising multiple knife holders and multiple knives installed therein, each of the first and second knife cylinders being adapted to perform a rotary cutting operation on the web after the images are printed thereon by the variable repeat printing means;
means for controlling a rotational speed of the first and second knife cylinders when the first or second cassette, respectively, is installed in the cutting apparatus; and
a software program that utilizes a desired product length as an input and utilizes the input to identify one of the multiple cassettes, a number of the knife holders thereof, and a rotational speed for the knife cylinder thereof that is an over-speed or under-speed condition relative to the web speed and achieves the desired product length, the software program generating an output to the variable repeat printing means that causes the variable repeat printing means to alter spacing between the images printed by the variable repeat printing means on the web.

2. The printing system according to claim 1, wherein the variable repeat printing means is a digital inkjet printer.

3. The printing system according to claim 1, wherein the first and second knife cylinders are fixed-circumference rotary cylinders.

4. The printing system according to claim 1, wherein the first and second knife cylinders have different circumferences.

5. The printing system according to claim 1, wherein the knife holders of each of the first and second knife cylinders are spaced circumferentially around the entire circumference thereof.

6. The printing system according to claim 1, wherein the knife holders of each of the first and second knife cylinders mount at least one pair of consecutive knives that is adapted to produce a bleed cut on the web and generate a bleed chip having a bleed chip size.

7. The printing system according to claim 6, wherein the software program identifies the rotational speed for the knife cylinder to achieve the desired product length and adjusts the bleed chip size without adjusting the pair of consecutive knives.

8. The printing system according to claim 6, wherein the over-speed condition at which the knife cylinder is operable is greater than 0% and up to 15% faster than the web speed.

9. The printing system according to claim 6, wherein the under-speed condition at which the knife cylinder is operable is less than 0% and as low as 5% slower than the web speed.

10. The printing system according to claim 1, wherein the knife holders of each of the first and second knife cylinders mount at least one knife that is adapted to produce a no-bleed cut on the web.

11. The printing system according to claim 11, wherein the over-speed condition at which the knife cylinder is operable is greater than 0% and up to 30% faster than the web speed.

12. The printing system according to claim 10, wherein the under-speed condition at which the knife cylinder is operable is less than 0% and as low as 10% slower than the web speed.

13. A method of performing a variable rotary cutting operation on a web using the printing system of claim 1, the method comprising:
inputting a desired product length into the software program and identifying therewith one of the multiple cassettes, a number of the knife holders thereof, and a rotational speed for the knife cylinder thereof that is an over-speed or under-speed condition relative to the web speed and achieves the desired product length;
generating with the software program the output to the variable repeat printing means that causes the variable repeat printing means to alter the spacing between the images printed by the variable repeat printing means on the web;
installing the one of the multiple cassettes having the number of the knife holders identified by the software program; and
feeding the web through the variable repeat printing means and thereafter through the one of the multiple cassettes, the variable repeat printing means printing images on the web having the altered spacing therebetween, and the controlling means rotating the knife cylinder of the one of the multiple cassettes at the rotational speed identified by the software program to cause the knife cylinder thereof to produce the desired product length.

14. A method of performing a variable rotary cutting operation on a web, the method comprising:
inputting a desired product length into a software program and identifying therewith a first of multiple cassettes that are interchangeably installable in a cutting apparatus, each of the multiple cassettes comprising a knife cylinder having multiple knife holders mounted thereto in which multiple knives are installed, the software program further identifying a number of the knife holders and a rotational speed for the knife cylinder that is an over-speed or under-speed condition relative to a web speed of the web and achieves the desired product length;
generating with the software program an output to a variable repeat printing means that is used by the variable repeat printing means to determine spacing between images printed by the variable repeat printing means on the web;
installing in the cutting apparatus the first cassette having the number of the knife holders identified by the software program; and
feeding the web through the variable repeat printing means and thereafter through the first cassette, the variable repeat printing means printing images on the web having the spacing therebetween, and the knife cylinder of the first cassette being rotated at the rotational speed identified by the software program to cause the knife cylinder to produce the desired product length.

15. The method according to claim 14, wherein the variable repeat printing means is a digital inkjet printer.

16. The method according to claim 14, wherein the knife cylinders of the multiple cassettes are fixed-circumference rotary cylinders.

17. The method according to claim 14, wherein at least two of the knife cylinders of the multiple cassettes have different circumferences.

18. The method according to claim 14, wherein the knife holders of the knife cylinder mount at least one pair of consecutive knives that produces a bleed cut on the web and generates a bleed chip having a bleed chip size.

19. The method according to claim 18, wherein the software program identifies the rotational speed for the knife cylinder to achieve the desired product length and adjusts the bleed chip size without adjusting the pair of consecutive knives.

20. The method according to claim 18, wherein the over-speed condition at which the knife cylinder is rotating is greater than 0% and up to 15% faster than the web speed.

21. The method according to claim 18, wherein the under-speed condition at which the knife cylinder is rotating is less than 0% and as low as 5% slower than the web speed.

22. The method according to claim 14, wherein the knife holders of the knife cylinder mount at least one knife that produces a no-bleed cut on the web.

23. The method according to claim 22, wherein the over-speed condition at which the knife cylinder is rotating is greater than 0% and up to 30% faster than the web speed.

24. The method according to claim 22, wherein the under-speed condition at which the knife cylinder is rotating is less than 0% and as low as 10% slower than the web speed.
